(19) United States
(12) Patent Application Publication
(10) Pub. No.: US 2003/0061222 A1
(43) Pub. Date: Mar. 27, 2003

(54) Image data warehousing

(76) Inventors: K. Douglas Gennetten, Ft Collins, CO (US); Michael L. Rudd, Fort Collins, CO (US); Michelle R. Lehmeier, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/964,132

(22) Filed: Sep. 25, 2001

(51) Int. Cl. G06F 7/00; G06F 17/00

(52) U.S. Cl. 707/100

(57) ABSTRACT

A data warehousing system, method, and logic for use with a plurality of uniquely-identifiable data capturing devices, and a warehouse for storing multiple sets of captured data from each device according to an identity of the device that captured each data set. The warehouse may comprise a service for that uniquely-names each data set from a single capture device and a service that maps the data sets to a domain of the warehouse corresponding to the device that captured the data set. The warehouse may also comprise a service that registers each data capturing device to an owner and a service that synchronizes data sets in the capturing devices with data sets in the warehouse.

### TECHNICAL FIELD

The present invention generally relates to data warehousing, and, more particularly, to storing captured data according to an identity of a device that captured the data.

### BACKGROUND OF THE INVENTION

WIPO Publication No. 99/48276 (applied for by Flash Point Technology, Inc. and corresponding to U.S. patent application Ser. No. 09/044,644, filed Mar. 18, 1998) discloses a method and system for implementing Internet access to images stored in a digital image capture unit that stores images within its internal memory. The captured unit accesses an ID server via the Internet and registers its identity and Internet address with the server. A user then accesses the capture unit by having a web browser query the ID server with the identity of the capture unit in order to retrieve the Internet address.

WIPO Patent Publication No. 00/07341 (also applied for by Flash Point Technology, Inc. and corresponding to U.S. patent application Ser. No. 09/127,514, filed Jul. 31, 1998) discloses a method for accessing a digital image capture unit via a communication network. The network uses a server computer system and a client computer system that are communicatively coupled with communication equipment. The method involves registering an address of the digital unit in an executable program on the server. The executable program is then accessed by the client computer system for connecting the digital image capture unit and the server.

Such conventional technologies suffer from a variety of drawbacks. For example, these systems require that each capture unit have its own network address. This can be difficult to implement, especially for Internet users who do not have static IP addresses. Similarly, providing an Internet address or Uniform Resource Locator (“URL”) for each unit can also be quite difficult.

### SUMMARY

These and/or other drawbacks of conventional technology are addressed here by providing a data warehousing system, method, and logic, comprising a plurality of uniquely-identifiable data capturing devices, and a warehouse for storing at least one set of captured data from each device according to an identity of the device that captured each data set. Also provided are a method and computer readable medium for warehousing data that comprises receiving at least one set of captured data from each of a plurality of uniquely-identifiable data capturing devices, and storing the received data sets according to an identity of the device that captured each data set. A shipping platform may also provide direct access to each of the stored data sets, such as via the Internet.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a conceptual diagram for an embodiment of a data warehousing system according to the present invention.

FIG. 2 is a schematic diagram of an embodiment of a communications platform for implementing the data warehousing system shown in FIG. 1.

FIG. 3 is a schematic diagram of an embodiment of the host computer shown in FIG. 2.

FIG. 4 is a flowchart for the services identified in FIG. 3.

### DETAILED DESCRIPTION OF THE PREFERRED EMBODIMENTS

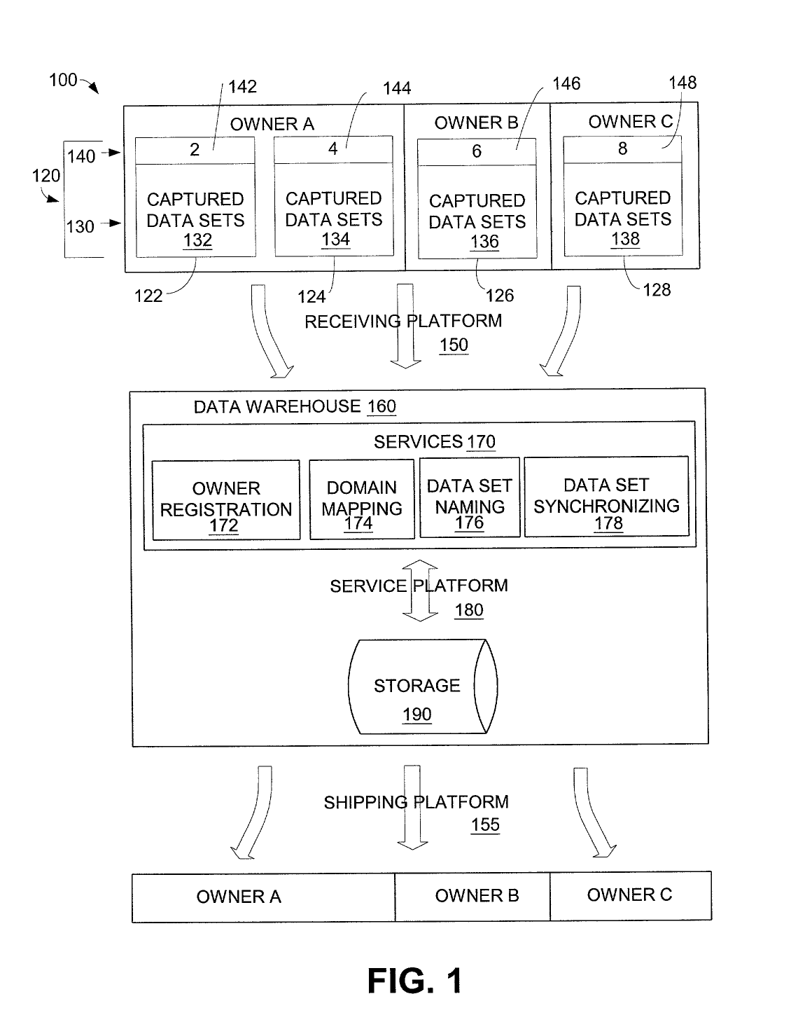

FIG. 1 is a conceptual diagram of an embodiment of a data warehousing system 100 according to the present invention. The system 100 includes a plurality of uniquely-identifiable data capturing devices 120 (specifically 122, 124, 126, and 128), a receiving platform 150, a shipping platform 155, and a data warehouse 160. Each of the data capturing devices 120 is owned and/or operated by an “owner” (specifically owner “A,” “B,” or “C”) for capturing and recording data sets 130 (specifically 132, 134, 136, and 138). For example, owner “A” uses data capturing device 122 for capturing data sets 132 and data capturing device 124 for capturing data sets 134. Similarly, owner B uses data capturing device 126 to capture data sets 136 while owner C uses data capturing device 128 to capture data sets 138. Each owner may own and/or operate any number of data capturing devices 120, and each device may capture any number of data sets 130. The system 100 may also be configured for any number of different owners.

The data capturing devices 120 are preferably image data capturing devices, such as digital cameras for providing digital photographs. However, a variety of other data capturing devices may also be used, including microphones (and recorders) for capturing sound data, receivers for capturing electromagnetic data, personal digital assistants for capturing personal data, television cameras for capturing motion picture data, and/or other devices for capturing other types of data.

Each of the data capturing devices 122-128 includes a corresponding identifier 142-148 for uniquely identifying the corresponding data capturing device among all of the data capturing devices 120. For example, data capturing device 122 includes a unique identifier 142 that, in this case, has been designated with the numeral “2.” Although each of the data capturing devices 120 has been provided with an identifier 140 that is numeric and corresponds to the last digit of the corresponding element number, a variety of other identifiers may also be provided, including alphabetic, textual, contextual, and/or pictorial identifiers. However, the identifiers 140 are preferably human and/or machine-readable, such as mechanically-, electrically-, chemically-, and/or optically-readable forms. In a preferred embodiment, the identifiers 140 correspond to manufacturer's serial numbers for each of the corresponding data capturing devices 120 and are readable by a computer. For example, these serial numbers may be stored in read-only memory inside the data capturing device.

A receiving platform 150 is provided for transferring the captured data sets 130 from the data capturing devices 120 to a data warehouse 160 while a shipping platform 155 is provided for transferring the data sets back to the appropriate owner. The receiving and shipping platforms may also coincide when data is shipped and received on the same platform. As described in more detail below, any such combined receiving/shipping platform 150/155 preferably includes a connection to a computer network, and/or internetwork such as the Internet. However, a variety of other types of communications platforms 150 may be provided for transferring the captured data sets 130 to the data warehouse 160, such as circuit-switched, point-to-point, wireless, optical, postal, facsimile, and/or manual delivery platforms.

The data warehouse 160 provides various services 170 before sending the captured data sets 130 over a service platform 180 to storage 190. The services 170 preferably comprises an registrar, registration mechanism, or even an owner registration service (interchangeably referred to hereafter as owner registration service 172), a domain mapper, domain mapping mechanism or even a domain mapping service (interchangeably referred to hereafter as domain mapping service 174), a data set namer, data set naming mechanism or even a data set naming service (interchangeably referred to hereafter as data set naming service 176) and a data set synchronizer, data set synchronizing mechanism or even a data set synchronizing service (interchangeably referred to hereafter as data set synchronizing service 178). It will be appreciated that fewer or more services may be provided by data warehouse 160 without department from the scope of the invention. Owner registration service 172 enables registering the owner of each capturing device 120 with its corresponding identifier 140, such as in a registration database. Domain mapping service 174 then maps the registered identifiers 140 to an area, or domain, in the storage 190 where all captured data sets 130 from a particular data capturing device 120 are stored. For example, each of the captured data sets 132 from a particular data capturing device 122 could be mapped to a particular region, such as “Region 2,” in the storage 190. Alternatively, or in addition, the storage domains may be mapped to a particular owner, for example, when more than one device 140 is owned by the same entity.

The data set naming service 176 then provides a unique name for each data set in the domain. For example, the data set names may be a sequential list of numbers, or the date and time at which the data set is received. Finally, the data set synchronizing service 178 synchronizes data sets in the capturing devices 130 with data sets that are already in the storage 190. For example, the synchronizing service 178 may prevent duplicate or redundant data sets from being sent to the storage 190.

The data warehousing system 100 may be implemented in a wide variety of electrical, electronic, computer, mechanical, and/or manual configurations. However, in the preferred embodiment discussed below, the data warehousing system 100 is at least partially computerized with various aspects of this system being implemented by software, firmware, hardware, or a combination thereof.

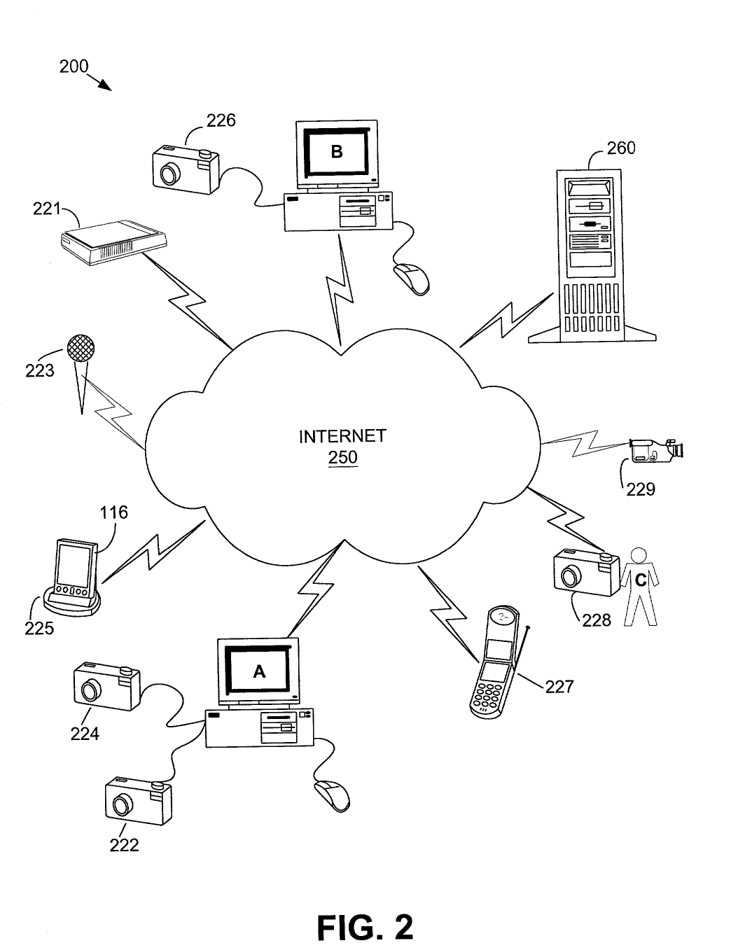

FIG. 2 is a schematic diagram of a computerized embodiment 200 of the data warehousing system 100 that is shown in FIG. 1. In FIG. 2, various data capturing devices 220 (specifically 221-229) are connected to a data warehouse (not shown in FIG. 2) on the host computer 260 by one or more communications platforms that interface with the Internet 250. The ownership entities of these data capturing devices 220 may correspond to hardware devices, such as personal computers A and B, or individuals such as person C. For example, computer A is registered to digital cameras 222 and 224, while computer B is registered to digital camera 226. Digital camera 228 is registered directly to an individual owner C, rather than through another piece of owner hardware. Although the examples discussed here use digital cameras as the preferred data capturing devices 120, other image and/or non-image data capturing devices may also be used such as, but not limited to, the scanner 221, microphone 223, personal digital assistant 225, mobile telephone 227, and video recorder 229.

The data capturing devices 220 may be continuously connected to the host computer 260 or intermittently connected, especially when data transmission costs are significant and must be minimized. Various conventional interfaces with the Internet 250 may be used and copies of the image may be forwarded to other hosts (not shown), for data sharing and/or backup. Various communication protocols and/or interfaces may be used including TCP/IP and CGI.

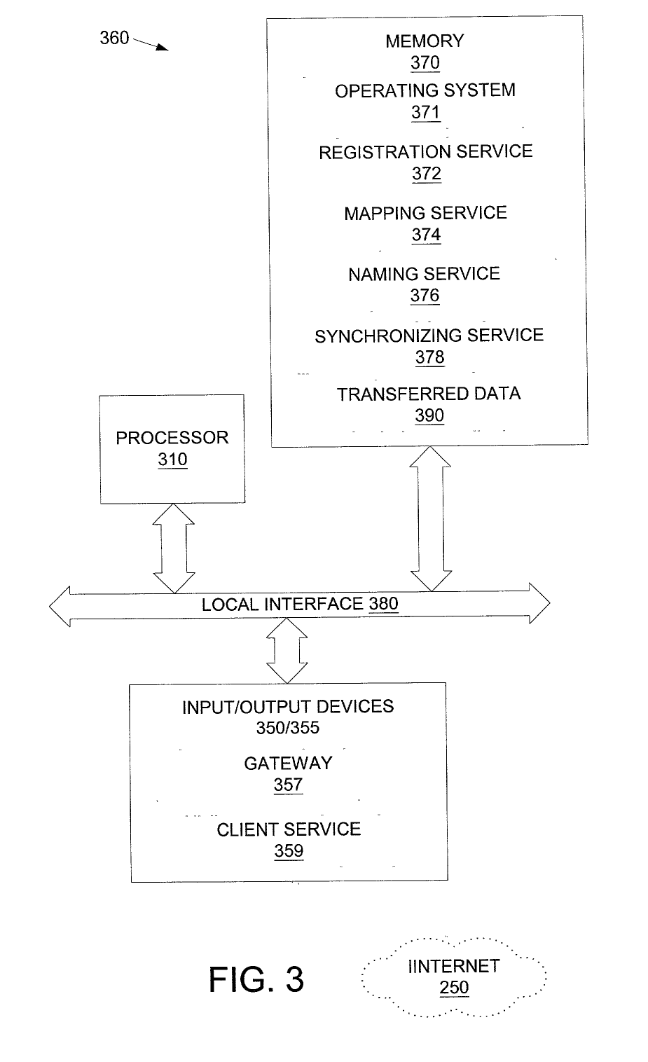

FIG. 3 is a block diagram of certain components 360 for implementing the data warehouse 160 on the host computer system 260, as described in more detail below. In terms of hardware architecture, the data warehouse system 360 includes a processor 310, memory 370, and one or more input and/or output (“I/O”) devices 350/355. Each of these components is communicatively coupled via a local interface 380 to the processor 310.

The local interface 380 may include one or more buses, or other wired and/or wireless connections, as is known in the art. Although not shown in FIG. 3, the interface 380 may have other communication elements, such as controllers, buffers (caches) drivers, repeaters, and/or receivers. Various address, control, and/or data connections may also be provided with the local interface 380 for enabling communications among the various components of the host computer 260.

The memory 370 may have volatile memory elements (e.g., random access memory, or “RAM,” such as DRAM, SRAM, etc.), nonvolatile memory elements (e.g., hard drive, tape, read only memory, or “ROM,” CDROM, etc.), or any combination thereof. The memory 370 may also incorporate electronic, magnetic, optical, and/or other types of storage devices. A distributed memory architecture, where various memory components are situated remote from one another, may also be used.

The processor 310 is preferably a hardware device for implementing software that is stored in the memory 370. The processor 310 can be any custom-made or commercially available processor, including semiconductor-based microprocessors (in the form of a microchip) and/or macroprocessors. The processor 310 may be a central processing unit (“CPU”) or an auxiliary processor among several processors associated with the computer 260 (FIG. 2). Examples of suitable commercially-available microprocessors include, but are not limited to, the PA-RISC series of microprocessors from Hewlett-Packard Company, U.S.A., the 80×86 and Pentium series of microprocessors from Intel Corporation, U.S.A., PowerPC microprocessors from IBM, U.S.A., Sparc microprocessors from Sun Microsystems, Inc, and the 68xxx series of microprocessors from Motorola Corporation, U.S.A.

The memory 370 stores software in the form of instructions and/or data for use by the processor 310. The instructions will generally include one or more separate programs, each of which comprises an ordered listing of executable instructions for implementing one or more logical functions. The data will generally include a collection of registration, mapping, naming, and/or synchronizing data, along with one or more stored media data sets corresponding to separate images that have been captured by the digital cameras 222, 224, 226, and 228. In the particular example shown in FIG. 3, the software contained in the memory 370 includes a suitable operating system (“O/S”) 371, a registration system or service 372, a mapping service 374, naming service 376, synchronizing service 378, and transferred data 390.

The operating system 371 implements the execution of other computer programs, such as the services 372-378, and provides scheduling, input-output control, file and data management, memory management, communication control, and other related services. Various commercially-available operating systems 371 may be used, including, but not limited to, the Windows operating system from Microsoft Corporation, U.S.A., the Netware operating system from Novell, Inc., U.S.A., and various UNIX operating systems available from vendors such as Hewlett-Packard Company, U.S.A., Sun Microsystems, Inc., U.S.A., and AT&T Corporation, U.S.A.

In the architecture shown in FIG. 3, the services 372-378 may be one or more source programs (or “source code”), executable programs (“object code”), scripts, or any other entity comprising a set of instructions to be performed as described in more detail below. In order to work with a particular operating system 371, any such source code will typically be translated into object code via a conventional compiler, assembler, interpreter, or the like, which may (or may not) be included within the memory 370. The programs for the services 372-378 may be written using an object oriented programming language having classes of data and methods, and/or a procedure programming language, having routines, subroutines, and/or functions. For example, suitable programming languages include, but are not limited to, C, C++, Pascal, Basic, Fortran, Cobol, Perl, Java, and Ada.

When the services 372-378 are implemented in software, as is shown in FIG. 3, they can be stored on any computer readable medium for use by, or in connection with, any computer-related system or method, such as the host computer 260. In the context of this document, a “computer readable medium” includes any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium comprise, but are not limited to, an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in the memory 370.

In another embodiment, where any of the services 372-378 are at least partially implemented in hardware, the system may be implemented using a variety of technologies including, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

The I/O devices 350/355 may connect the warehouse system 360 to the Internet 250 and/or other communications platform. For example, as illustrated in FIG. 3, the I/O devices 350/355 may include a gateway 357 and/or client server 359. The gateway 357 may include a protocol converter for connecting networks that use different protocols, a router for folding packets between networks, and/or an interface (such as a Common Gateway Interface) to facilitate communication between various software systems. The client service 359 will typically include a file server for responding to HTTP requests from client computers, such as computers A and B. However, FTP and/or other Internet protocols may also be implemented for the client service 359.

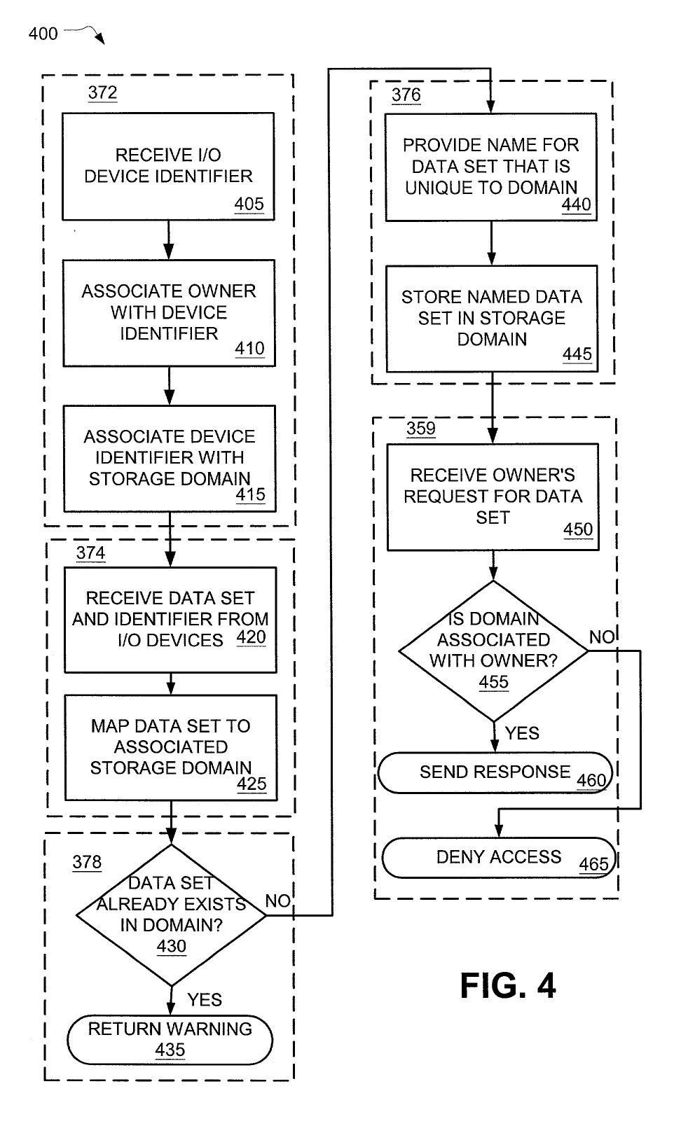

Once the data warehouse system 360 is accessed, the processor 310 executes instructions in the operating system 371 that are stored within the memory 370 (or elsewhere in the host computer system 260). The processor 310 will also receive and execute further instructions in the various services 372-378 with the data 390, so as to generally operate the warehouse system 360 pursuant to the instructions and data contained in the software and/or hardware as described below with regard to FIG. 4.

FIG. 4 is a flow diagram for one embodiment of the services 372-378 shown in FIG. 3. More specifically, FIG. 4 shows the architecture, functionality, and operation of a software system 400 that may be implemented within the data warehouse system 360 shown in FIG. 3. However, as noted above, a variety of other computer, electrical, electronic, mechanical and/or manual system may be similarly configured.

Each block in FIG. 4 represents an activity, step, module, segment, or portion of computer code that will typically comprise one or more executable instructions for implementing the specific, logical, function(s). It should also be noted that, in various alternative implementations, the functions noted in the blocks will occur out of the order noted in FIG. 4. For example, multiple functions in different blocks may be executed substantially concurrently, in a different order, incompletely, and/or over an extended period of time depending upon the functionality involved. Various steps may also be manually completed.

FIG. 4 illustrates various steps associated with each of the registration service 372, mapping service 374, synchronizing service 378, naming service 376, and client service 359. At step 405 of the registration service, the warehouse system 360 (FIG. 3) on the host computer 260 (FIG. 2) receives device identifiers 140 (FIG. 1) from various owners. The owners are then associated with their respective identifiers at step 410 and the device identifiers 140 are associated with a particular domain in the storage 390 at step 415. For example, upon purchasing a device, owner A might be asked to register an electronic serial number “2” with the owner's name and address in a database.

There may also be an additional charge for the registration service 372, in which case, the registration service may be further configured to accept payment for the registration. The device identifier may not necessarily be known by the owner. Similarly, the storage domain associated with each identifier may, or may not necessarily be known to the owner. For example, the storage domain may simply correspond to a pathname, or directory, that is selected by the computer. Alternatively, owner A may be assigned a domain of his or her choice, such as “A.photos.hp.com” or “JaneDoesCamera2.com.”

Upon completion of the registration service 372 data is captured and sent to the warehouse. The mapping service 374 is then implemented for each data set and identifier that is received from a device 120, 220 (FIGS. 1 and 2) at step 420. In addition to receiving the data sets and identifiers from the devices 120, the mapping service 374 maps each received data set to an associated storage domain at step 425. For example, the naming service 376 will query the registration service 372 for the pathname that is associated with a particular identifier 142 for a data set 132 from a device having “2” as its identifier. In this way, the identification of the owner may be securely segregated from the location of the owner's transferred data 390 in memory 370.

The synchronization service 378 synchronizes data sets in the data capturing devices 140 with data sets in the memory 370. For example, the synchronization service 378 will determine whether a transferred data set already exists in its associated domain at step 430. If the data set already exists, then an appropriate warning may be returned at step 435. If it is unlikely that the received data set is a duplicate of a stored data set, then the system 400 proceeds to the naming service 376.

The naming service 376 begins at step 440 by providing a name for the received data set that is unique to the domain that is associated with the device that captured the data set. For example, the naming service may provide file names that are merely a numerical sequence for each data set that is transferred. Alternatively, the name could be derived from the date and/or time that the data set is received by the naming service. The name may also be provided by the data capture device 142 or by its owner for easy reference. Once the data set is named, then it is stored in the associated domain at step 445.

Once the named data set is stored at step 445, an owner may later request that data set be returned at step 450 by the client service 359. The client service 359 will first determine whether the domain in which that data set is stored is associated with the owner at step 455. For example, the client service 359 may query the registration service 372 to determine whether the owner and domain are, in fact, associated. If the association is correct, then the request is fulfilled at step 460. Otherwise, the request is denied at step 465.

The client service 359 preferably provides direct access to the stored data sets via the Internet. For example, the client service 359 may include a server, such as an HTTP server, that provides access to each of the stored data sets via a unique Uniform Resource Locator that is associated with each data set. In this manner, image-laden documents can be created, modified, stored, or otherwise manipulated using various Internet protocols, such as the HTTP protocol.

Security may be further enhanced by using passwords, digital signatures, and/or a public notary. Some or all of the registration data may also be stored separately from the transferred data 390 (FIG. 3). Owners may be allowed to grant access to their data to others in order to facilitate data sharing. In fact, each data set is preferably assigned a permanent or semi-permanent Uniform Resource Locator (“URL”) by the present invention so that a data set can be easily accessed at a future date. Although all data sets would preferably be stored in their richest, highest-resolution form, they could also be configured for summary presentation (e.g., thumbnails).

1. A data warehousing system, comprising:
a plurality of uniquely-identifiable data capturing devices; and
a warehouse for receiving and storing at least one set of captured data from each device according to an identity of the device that captured each data set.

2. The data warehousing system recited in claim 1 wherein said warehouse comprises a naming service for uniquely-naming each data set from a single capture device.

3. The data warehousing system recited in claim 1 wherein said warehouse comprises a mapping service for mapping each data set to a domain of the warehouse corresponding to the device that captured the data set.

4. The data warehousing system recited in claim 1 wherein said warehouse comprises a client service for providing access to each of the stored data sets.

5. The data warehousing system recited in claim 1 wherein said warehouse comprises a registrar for registering each of the data capturing devices to an owner.

6. The data warehousing system recited in claim 1 wherein said warehouse means comprises data set synchronizer for synchronizing data sets in the data capturing devices with data sets in the warehouse.

7. The data warehousing system recited in claim 1 wherein said data capturing devices are selected from the group consisting of cameras and scanners.

8. A method of warehousing data, comprising the steps of:
receiving at least one set of captured data from each of a plurality of uniquely-identifiable data capturing devices; and
storing the received data sets according to an identity of the device that captured each data set.

9. The method recited in claim 8, further comprising uniquely-naming each data set from a single capturing device.

10. The method recited in claim 8, further comprising mapping each data set to a domain corresponding to the device that captured the data set.

11. The method recited in claim 8, further synchronizing the received data sets with stored data sets.

12. The method recited in claim 8, further comprising registering each of the data capturing devices to an owner.

13. The method recited in claim 8, wherein said data capturing devices are selected from the group consisting of cameras and scanners.

14. A computer readable medium for warehousing data, comprising:
logic that receives at least one set of captured data from each of a plurality of uniquely identifiable data capturing devices;
logic that stores the received data sets according to an identity of the device that captured each data set; and
logic for providing direct access to each of the stored data sets via the Internet.

15. The computer readable medium recited in claim 14, further comprising logic that uniquely-names each data set from a single capturing device.

16. The computer readable medium recited in claim 14, further comprising logic that registers each of the data capturing devices to an owner.

17. The computer readable medium recited in claim 14, further comprising logic that synchronizes the received data sets with stored data sets.

18. The computer readable medium recited in claim 14, wherein the data capturing devices are selected from the group consisting of scanners and cameras.
